(19) United States
(12) Patent Application Publication
(10) Pub. No.: US 2004/0076283 A1
(43) Pub. Date: Apr. 22, 2004

(54) Telecommunication system

(76) Inventor: Thomas A. Egan, West Chester, PA (US)

Correspondence Address: Robert S. Lipton, Esquire, LIPTON, WEINBERGER & HUSICK, 201 North Jackson Street, P.O. Box 934, Media, PA, 19063-0934, US

(21) Appl. No.: 10/272,545

(22) Filed: Oct. 16, 2002

(51) Int. Cl. H04M 3/00; H04M 5/00

(52) U.S. Cl. 379/325

(57) ABSTRACT

A system is disclosed for providing various telecommunications-based services to end users in subdivisions for residential and business uses and office buildings. The telecommunications services are conveyed from an access point to end users by infrastructure owned by a local infrastructure provider. These services may be provided by various service providers or other entities selected by the end users.

### FIELD OF THE INVENTION

The present invention in general relates to the providing of various telecommunication services to customers. More particularly it relates to providing such services to customers by a local infrastructure provider in subdivisions as hereinafter defined. Telecommunications as used herein means the transmission of information over a distance by an electronic digital transmission of information.

### BACKGROUND OF THE INVENTION

High speed electronic communication is presently provided to customers in residential subdivisions and office parks and the like by telephone and cable television companies. These services are provided through physical means including wire and fiber optic strands as well as by wireless means. Electronic communication in any form are referred to in this application as “telecommunications services,” including telephone, cable TV, internet service, internet service over cable TV cables, communications signals carried by fiber optic cable, and all other communications by electronic means. Infrastructure to provide telecommunications services is referred to in this application as “telecommunications infrastructure.”

As used herein “wire” shall include both metal wire, fiber optic strands and any other physical medium which can carry digital signals. These wires are placed throughout a subdivision either above or below ground, although below ground is used almost exclusively in new construction. In either case, legally binding permission must be obtained from the owner of the ground or in some cases the owner of a pre-existing easement or right-of-way. Typically this is accomplished by obtaining legally binding permission from the developer of a subdivision before construction is started or by obtaining legally binding permission from an easement owner.

As used in this application, a “legally binding permission” is an easement, right-of-way or ownership interest in fee allowing access to a property to install, use or maintain telecommunications infrastructure. As used in this application, the term “subdivision” means a parcel of property that is divided into smaller parcels for the erection of a building or buildings on the smaller parcels and for sale or lease of the smaller parcels or buildings or both to others. A subdivision may be a residential subdivision, where a real estate developer subdivides the larger parcel, erects homes on the resulting smaller parcels, and sells the smaller parcel and the home to a buyer. A subdivision may be condominium, where an existing or new apartment or office building is divided into separate condominium apartments or offices and sold to buyers. A subdivision may be an office, industrial or business park where a parcel is divided into smaller parcels and sold or leased to office, industrial or business users. A subdivision may be an office or apartment building, where a single building is constructed on a single parcel of real property, and portions of the building, such as an apartment or office, are leased or rented to lessees or renters.

For purposes of this application, a provider of services, such as local or long distance telephone, Internet, cable television, entertainment, gaming, medical monitoring, advertisements and other Internet Protocol-based and non-Internet Protocol-based services, is referred to as a “service provider.” Services are generally provided to a property by the owner of the infrastructure (“Infrastructure Provider” or “IP”), e.g. the owner of the telephone or cable television infrastructure. Builders or developers are generally required by law to grant easements to utility providers such as the providers of gas, electricity, water and phone services. In some cases, particularly in recent construction, easements may be granted to the local cable television company (cable television providers are generally legally not considered utilities). In those instances where the service provider has not been granted an easement, it must either use the easement of another service provider or, if available, the right-of-way granted to the local government for streets and utilities.

A distinction must be made between IPs, those entities which own or control the wires and other associated infrastructure, and service providers that use those wires to provide services using the infrastructure. At present, IPs also are service providers, providing services using their infrastructure, e.g., telephone service, cable television services, both of which are used to provide high speed internet services, e.g., DSL service in the case of phone companies and the inherent ability of cable television infrastructure to provide such service. Those IPs can provide multiple services. At the present time most cable television companies must pay a fee to an owner of the right-of-way in a subdivision in order to install their infrastructure. The owners of such rights-of-way are generally either the phone company or the local municipality, both of which charge a fee for such use. The fact that IPs also may be services providers inherently affects the cost and variety of services which may be provided to the end user due to the fact that they have a defacto monopoly with respect to high speed wires.

This lack of a right by other IPs to install their own wires prevents competition or, if the right is granted to do so, increases its costs which it passes on to their customers thus increasing their costs also.

There are presently other problems with the status quo, particularly in residential subdivisions. Builders are generally not technology proficient. Accordingly, the homes are generally wired for telephone service only. It is then inconvenient and expensive for a home owner to have a finished home “wired” for high speed digital telecommunication service. This requires placing wires in walls and the like which is expensive and which may cause damage which in turn will have to be repaired.

As indicated, the primary infrastructure is, of course, the wires which carry the information. However, the wires must be supported by other infrastructure which includes the various cables which are constructed from wire and the conduits through which the cables and/or wire are contained in order to protect them and facilitate access thereto for repair and maintenance purposes. The conduits also facilitate the addition and/or replacement of cables and wires. Another problem with existing IPs is that in many cases they are unable to provide data transmission in both directions at the same speed or, if they can, a surcharge is imposed; all to the end user's detriment or expense.

### SUMMARY OF THE INVENTION

The aforesaid problems may be overcome or at least minimized by providing a Local Infrastructure Provider (“LIP”) who will hold an easement, right-of-way or fee interest in real property between an access point for a subdivision and each home, business or office in the subdivision. The easement, right-of-way or fee interest is hereinafter referred to as the “LIP real estate.” The LIP will own the wires or other telecommunications infrastructure running from the access point through the LIP real estate to each parcel of property within the subdivision. The telecommunications infrastructure located on LIP real estate is hereinafter referred to as “local infrastructure.”

The local infrastructure will connect electronically a residence, building, office, condominium or apartment located within the subdivision to the access point. The access point, is one or more physical locations where local infrastructure connects to telecommunications infrastructure owned by infrastructure providers, thereby providing telecommunications services from service providers to end users within the buildings of the subdivision. Telecommunications facilities to which the local infrastructure may connect at the access point is hereinafter “external infrastructure.” A provider of external infrastructure is hereinafter referred to as an “external infrastructure provider.” A provider of telecommunications services through the external infrastructure to the access point is an “external service provider.”

The LIP will install wire(s) and other local infrastructure on LIP real estate and may install wires in buildings selected bit the builder or the applicable home or business owner. The home or business owner or the occupier of the premises to whom services are rendered by the LIP is referred to as the “end user.” Installation of wiring during construction will cost less than installing the wiring after the construction of the building has been completed and without causing the damage and inconvenience that post construction installation would entail. The LIP as an entity knowledgeable in telecommunications would install the wires on the LIP real estate and in buildings in such a manner that they can be serviced and upgraded as necessary in a cost effective manner.

As an independent owner of the wire, the LIP will make appropriate arrangements to provide telephone and other telecommunication services e.g., cable television, internet access, etc., to the end user utilizing the facilities of external infrastructure providers. The LIP will pass through telecommunications service from an external service provider to the end user.

“Independent” as used herein means that the LIP will not own or control any entity which provides such services nor will it provide such services itself. By being independent it can provide the customer such services offered by other providers by selecting those who provide their services on a cost effective basis.

### BRIEF DESCRIPTION OF THE DRAWINGS

FIG. 1 is a schematic representation of a typical real estate subdivision;

FIG. 2 is a flow chart showing the methodology of the present invention.

### DETAILED DESCRIPTION OF THE PREFERRED EMBODIMENT

In describing a preferred embodiment of the invention, specific terminology will be selected for the sake of clarity. However, the invention is not intended to be limited to the specific terms so selected, and it is to be understood that each specific term includes all technical equivalents that operate in a similar manner to accomplish a similar purpose.

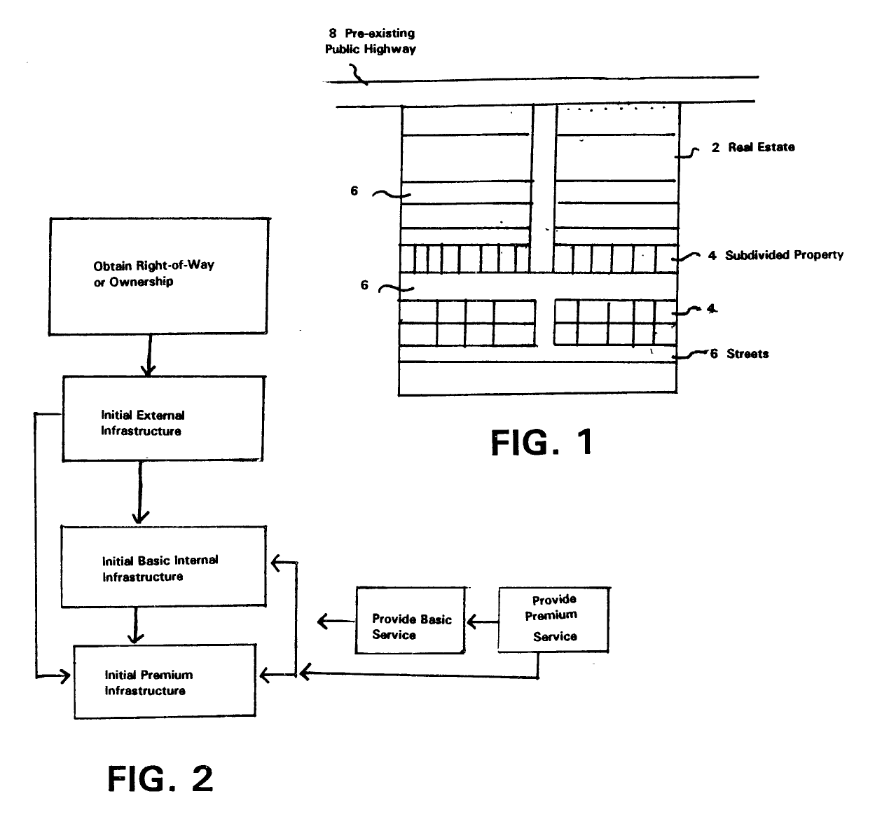

FIG. 1 shows a parcel of real estate 2 which has been subdivided into individual properties 4. Streets 6 are shown which permit access to the properties.

Subdivided real estate 2 may be accessed by one or more pre-existing public highways or streets 8 (only one is shown). As is customary in the vast majority of subdivisions, the owner/developer of the real estate will either convey title to the streets to the local municipality or, in the alternative, will grant the local municipality an easement or right-of-way to the land upon Which the streets will be located for use by public utilities and others who may make appropriate business arrangements with the municipality. In the case of a public easement, the municipality will be responsible for maintaining the streets 6 after they have bean constructed by the developer. Although the subdivided real estate shown in FIG. 1 is representative of a residential subdivision, the basic principles discussed therein apply equally to a commercial subdivision. Such commercial subdivisions may be used as a business park, shopping mall or any other commercial purpose. The basic principles also apply to multiple dwelling units, commonly referred to as “MDUs” which include apartments, condominiums, offices in office buildings, etc.

The properties 6 are provided with the usual utilities, e.g., electricity, sewers, water, telephone, and natural gas (where applicable). Physical means for providing such services from outside the subdivision must be provided from a location outside the subdivision to all the properties throughout the subdivision. Such physical means include, but are not limited to, cables and wires for transmitting electricity, gas mains, sewage pipes, telephone lines, etc. All of the foregoing constitutes the utility infrastructure for the development. Such infrastructure is generally physically located on the property which is owned by, or subject to an easement in favor of the local municipality for such use. Such use may also include use as a street. In some cases an easement may be granted to the local power company for electricity and to the local phone company for telephone access, and to the gas company for gas and to the water company for water. Such easements may be located on the individuals' properties 4 or the streets 6.

In order to provide the occupants of the subdivision with the optimum and most cost efficient telecommunications infrastructure for the subdivision, the infrastructure, wires in this case, should be owned by an independent entity. As previously discussed herein, such an entity will be referred to as an LIP. The LIP will work with the developer of the subdivision so that proper components for the infrastructure are selected and located so that the infrastructure may be easily upgraded and, if necessary, replaced due to the changing nature of the technology.

In order to accomplish this objective the developer will convey sufficient rights to the LIP with respect to real estate within the subdivision. These rights could be effectuated by conveying the title to appropriate real estate on which the infrastructure will be located or by conveying an easement or right-of-way with respect to the property to the LIP. Such property may be located anywhere within the subdivided property subject to the requirements for the selected infrastructure design and the specifications associated therewith.

The LIP may, in conjunction with the developer, provide basic telecommunications infrastructure within each building constructed on properties 4 (hereinafter “building infrastructure”). The basic infrastructure would include that commonly found in most buildings, e.g., wiring for telephone and cable television. The LIP may also work directly with the builder and/or the purchaser of properties 4 to provide premium infrastructure within the buildings being constructed on the property. Such premium infrastructure would include additional high-speed telecommunication wires such as fiber optic cables or coaxial cables having specifications different than that provided in the basic infrastructure. Additionally, the premium infrastructure could include the ability to be upgraded or have new infrastructure installed with minimal impairment or harm to the interior of the building and therefore at less cost than that which would be required if basic infrastructure were selected and in place.

The LIP will offer telecommunications services to the end users owning, using or occupying the building or buildings erected or to be erected in the subdivision. If the end user accepts the offer, the LIP will connect the end user to external service providers through the local infrastructure. The LIP will receive telecommunications services from an external service provider over external infrastructure. The LIP will pass the services to an end user though the local infrastructure.

The LIP will be able to arrange to provide the infrastructure end users with telecommunications services on a more cost effective basis than heretofore. Numerous telecommunications providers are attempting to obtain exclusive control of communications infrastructure. Telephone companies, cable television companies and electric companies, all of which own an infrastructure which may be used to provide telecommunications services, each want to have control of the infrastructure so that they can control the services provided via that infrastructure. The LIP will be independent, i.e., will not own or be controlled by the providers of services over the infrastructure owned by the LIP. This will minimize, if not prevent, the major providers of some telecommunications services from having the ability to exercise undue control of services and the pricing thereof offered to end users who obtain such services through the local infrastructure. Thus, the end user will have a greater choice in selecting the provider of particular services and on a more cost effective basis. The end user may also obtain the benefit of telecommunications services that would not otherwise be available without additional wiring or installation costs by the end user, if such services are available at all with conventional infrastructure.

The LIP may also provide services which are provided via satellite to end users within the subdivision by using a single antenna or substantially fewer satellite antennas and receivers than if each user had its own antenna. Not only would this result in decreased cost, it would also permit wide-spread use of satellite-based services within the subdivision without the negative effects of multiplicity of satellite antennas within the subdivision. Such services may also be provided by ground-based microwave or laser sources.

As previously discussed, the infrastructure includes wires, cable, coaxial cable, fiber optic cable, short range radio or microwave transmissions, or any suitable physical means for providing high speed transmission of digital based services. The infrastructure will also include a small building for containing interface apparatus such as a junction box between the LIP owned infrastructure and the infrastructure external to the subdivision. Such external infrastructure will generally be owned by telephone companies, cable companies, electric companies and various other parties. The LIP infrastructure is not limited to receiving input from and transmitting to, one provider but may receive and transmit from and to multiple sources.

As previously referred to, the present methodology, although explained within the context of s real estate subdivision, may be applied equally to end users within a single building. In this instance the LIP would obtain rights to install, maintain and upgrade its own infrastructure within the building. Thus, the end users within the building would obtain the same benefits as end users within a subdivision.

The LIP may also act as a billing agent for each of the users within the subdivision by making arrangements with the service providers to bill end users using its wires for each service an individual user subscribed to, thus providing the end user with a single statement for such service as well as its own services.

FIG. 2 shows a flow chart of the methodology discussed above. As is shown, the first step is for the LIP to obtain a right to an easement or right of way or title to real estate in which the local infrastructure will be located. After those rights have been obtained, the local infrastructure will be installed throughout the subdivision. The LIP may install the basic infrastructure or may install the applicable premium infrastructure within each building while it is being constructed. The LIP would then provide either basic service or premium service to each of the subscribers within the subdivision.

It should be pointed out that the LIP will not have the exclusive right to provide external and infrastructure within the subdivision. Each property owner will, of course, be able to select their own party to install such infrastructure. The present methodology does not prevent other parties from having telecommunications infrastructure in a subdivision. Municipalities can still grant rights to cable television operators and telephone companies to install their own infrastructure using real estate that they have rights to. Similarly, such rights may also be provided by electricity, gas and other utility providers.

Although this invention has been described and illustrated by reference to specific embodiments, it will be apparent to those skilled in the art that various changes and modifications may be made which clearly fall within the scope of this invention. The present invention is intended to be protected broadly within the spirit and scope of the appended claims.

1. A method of providing telecommunications services to an end user in a subdivision, the method comprising:
a. obtaining a right by a local infrastructure provider, said right including a legally binding permission to install, replace and maintain a local infrastructure from an access point, through a parcel of real estate being developed as the subdivision;
b. installing said local infrastructure in said parcel of real estate;
c. offering by said local infrastructure provider to a builder or to said end user to install a building infrastructure in a building being constructed;
d. installing said building infrastructure in said building being constructed upon acceptance by the builder or the end user of said offer to install said infrastructure;
e. receiving telecommunications services from an external service provider at said access point; and
f. passing the telecommunications services from said external infrastructure provider to the end user utilizing said local infrastructure and said building infrastructure.

2. The method of claim 1, said external service provider being an external infrastructure provider.

3. The method of claim 1, said building being selected from a list comprising single family residence, duplex, twin, multi-family residence, condominium, apartment, building housing a single business, building housing multiple businesses, business condominium, and office building.

4. The method of claim 3, said right comprising an easement, right-of-way or interest in fee in all or a portion of said parcel of real estate.

5. The method of claim 4, said local infrastructure being selected from a list comprising telephone, cable TV, DSL, cable internet access, optical fiber, and short-range wireless transmission.

6. The method of claim 5, said local infrastructure and said access point serving a single one of said subdivisions.

7. The method of claim 6, said local infrastructure provider offering the end user a plurality of choices of said external service providers; the end user selecting among said plurality of choices of external service providers.
